(19) United States
(12) Patent Application Publication
(10) Pub. No.: US 2013/0262964 A1
(43) Pub. Date: Oct. 3, 2013

(54) DEVICE AND METHOD FOR THE READING AND STORING OF DATA

(71) Applicant: MINEBEA CO., LTD., Nagano-ken (JP)

(72) Inventors: Martin Winker, Wurmlingen (DE); Sebastian Riemer, Unterkirnach (DE)

(21) Appl. No.: 13/854,529

(22) Filed: Apr. 1, 2013

(30) Foreign Application Priority Data
Apr. 2, 2012 (DE) 102012102856.7

(51) Int. Cl. G06F 11/10

(52) U.S. Cl. CPC G06F 11/1004
USPC 714/807

(57) ABSTRACT

A method for reading data from an electronic data memory. The data lie as data words in the memory, wherein each data word is available at a unique address. In addition, the data word is available as an identical copy at a second address having a fixed address offset (N) in the same data memory or the copy is available at an address of a different data memory that is linked through a unique assignment instruction to the address of the data word in the data memory. A checksum (CRC) for each data word is additionally stored in the data memory. For reading a data word, the data word and the checksum (CRC) are initially read. Then the checksum (CRC) is calculated via the data word and compared to the read checksum (CRC). If the checksums (CRC) do not correspond to one another, the read operation is repeated with the copy of the data word. If this value is also invalid, a default value is used and/or an error message is issued.

### INCORPORATION BY REFERENCE

The following documents are incorporated herein by reference as if fully set forth: German Patent Application No. 102012102856.7, filed Apr. 2, 2012.

### BACKGROUND

The invention describes relates to a method for writing data into and for reading data from an electronic data memory, as well as a microcontroller that is designed to implement the method.

The invention is to be particularly seen in the context of an integrated microcontroller that is used for controlling an electric or electronic device, such as an actuator in a motor vehicle. The microcontroller generally has access to a data memory in which the operating program and, for example, operating parameters of the actuator or other data are stored.

It is particularly important in the motor vehicle industry to ensure that the actuator is operated at all times with valid operating parameters.

Although electronic memories have very high data security, it is nevertheless possible for some regions or individual memory cells to suffer data loss. This may be caused, for example, through external influences or through malfunctions in the memory itself. This applies equally to both magnetic memories, particularly hard disks, as well as to solid state memories, such as EEPROMs or flash memories. A data loss of this kind may then result in the unavailability of any valid operating parameters.

This kind of data loss cannot be prevented. It is only possible to take measures that can correct a data error.

For the operating program (BIOS) in the case of computer main boards it is known, for example, to use two identical ROMs or flash memories, just in case one of the data memories is affected by such a data loss. However, this is not always possible in an integrated control since there is often not enough space available on the circuit board of the control and the costs are excessively high.

### SUMMARY

It is thus the object of the invention to create a simple and sufficiently secure method of data storage that can be realized using a low-cost microcontroller for integrated control tasks.

This object has been achieved by a microcontroller having the characteristics according to the invention and a method according to the invention.

According to an embodiment of the invention, all data is stored in data words in the data memory. A data word has a defined width, for example, 3 bytes.

Each data word is additionally provided with a checksum that, together with the data word, is stored in the data memory at a unique address in order, for example, to allow a cyclic redundancy check (CRC). A CRC checksum, for example, or another known checksum is suitable for use as a redundancy check.

Below, the writing or reading of data at a memory address is used within the meaning of writing or reading data in the data memory assigned to a memory address.

Because of the limited resources in the microcontroller, according to an embodiment of the invention a checksum is used that is easy to calculate, such as an inverted modulo-256 sum, over all the bytes of the data word. This checksum makes it possible to identify an error in the data word. For the sake of simplicity, however, the checksum does not contain any information on the restoration of the data word, since this would overtax the processing power and memory capacity of a small integrated microcontroller.

To allow correct data to be available at all times, even in the event of an error, according to an embodiment of the invention all data words are stored several times in the data memory. For determining the second address, according to an embodiment of the invention a fixed address offset is used that is simply added to the first address. This can also be implemented in a simple microcontroller. As an alternative, instead of the address offset, another unique assignment instruction between at least two memory addresses may be used, where the at least two memory addresses may also be located in different memories.

If a data word is not valid, which can be determined through the checksum, according to an embodiment of the invention a data copy is accessed. If none of the data words found in the data memory are valid, according to an embodiment of the invention a default value is used and/or an error message is issued and/or where required, an error function is executed. This default value can be stored in a separate data memory, such as a flash memory, as read-only data for example. Preferably at the initial start up of the application, the default value can then be copied from the separate data memory into the actual data memory. For all future start ups of the application, it is no longer necessary to copy all the default values from the separate data memory into the data memory.

For example, the default values may also be provided in the separate data memory with a checksum that, on starting the application, is compared with a checksum of the data stored in the data memory. Should these checksums not correspond to one another, the respective default values are again copied into the data memory. It is particularly advantageous to provide a default value for the data required for operation. This could include, for example, the rotational direction of an electric motor or a travel distance of an actuator.

A basic requirement for data security is that the data is available in the data memory in several instances.

The data in the data memory may, for example, be read-only data that is stored in the data memory only once, for example, after the successful initial start up of the system. The data, however, may also be continuously changed during operation by the microcontroller and stored again in the data memory for future use.

An embodiment of the invention thus comprises a method by means of which data is written into the data memory, where at least one copy is automatically stored in at least one other address in the same data memory having a fixed address offset or in another address of a different data memory that can be determined through a fixed assignment instruction from the first address. The reading method according to an embodiment of the invention can thereby be used and valid data is always available.

In the method according to an embodiment of the invention, data security may be arbitrarily increased in that instead of one copy, several copies are kept in the data memory. The only limiting factor being the memory that is available.

In an alternative embodiment of the writing method according to an embodiment of the invention, an address range having several addresses is reserved for each data word. Here however, in contrast to the above-described writing method, only one data word is written, but into a different address of the reserved addresses for each write operation. The address containing the oldest contents being thereby always overwritten. This alternative method is particularly suitable for storing counter readings, where the counter reading for each write operation is incremented, for example, by 1.

When reading, only the address with the most recent value is then ever read. If this value is invalid, as in the reading method described above, the next address in the address range is read. The difference now is that not the most current, but an older counter reading is stored here. The value read out differs only by the last increment value, for example, 1 from the correct value.

For many applications, however, it is absolutely non-critical if the counter reading has a minimal discrepancy. It is thus unimportant for the operation of a device whether the operating time counter shows an hour more or less, which is why such an error, although not desirable, is however usually acceptable, since here, for example, the magnitude of the value remains unchanged.

In order to obtain, for example, the latest value for a counter, all the addresses in the address range are read and compared to one another. The largest value here is the latest value.

If the content of the counter is critical, it is of course clear that for each address in the address range at least one other copy can be stored in at least one other address range, so that exactly the right value is available.

In one embodiment, the invention also comprises a microcontroller that has a means of reading a data word from the data memory, a means of generating a checksum over this data word and a means of calculating an address offset. This makes it suitable for implementing the method according to an embodiment of the invention. An embodiment of the invention is described hitherto such that the data and the data copies are stored in the same data memory but in a memory address having a fixed offset compared to the memory address of the data. However, in another embodiment of the invention, the data copies may equally be stored in a different memory, where a unique assignment instruction between the memory address of the data and the memory address of the data copy must exist.

In an advantageous embodiment of the invention, the microprocessor additionally has a means of writing data in the data memory in accordance with a method according to an embodiment of the invention.

### BRIEF DESCRIPTION OF THE DRAWINGS

The method according to the invention is described in more detail below on the basis of a preferred embodiment with reference to the enclosed drawings.

The figures show:

FIG. 1 a schematic view of a data memory having a plurality of data words,

FIG. 2 a schematic view of a data memory having one data word for which a plurality of addresses of an address range are reserved,

FIG. 3 a schematic view of an actuator for controlling air flaps in a motor vehicle,

FIG. 4 a block diagram of a microcontroller according to an embodiment of the invention,

FIG. 5 a flow chart of the reading method, and

FIG. 6 a flow chart of the writing method.

### DETAILED DESCRIPTION OF THE PREFERRED EMBODIMENTS

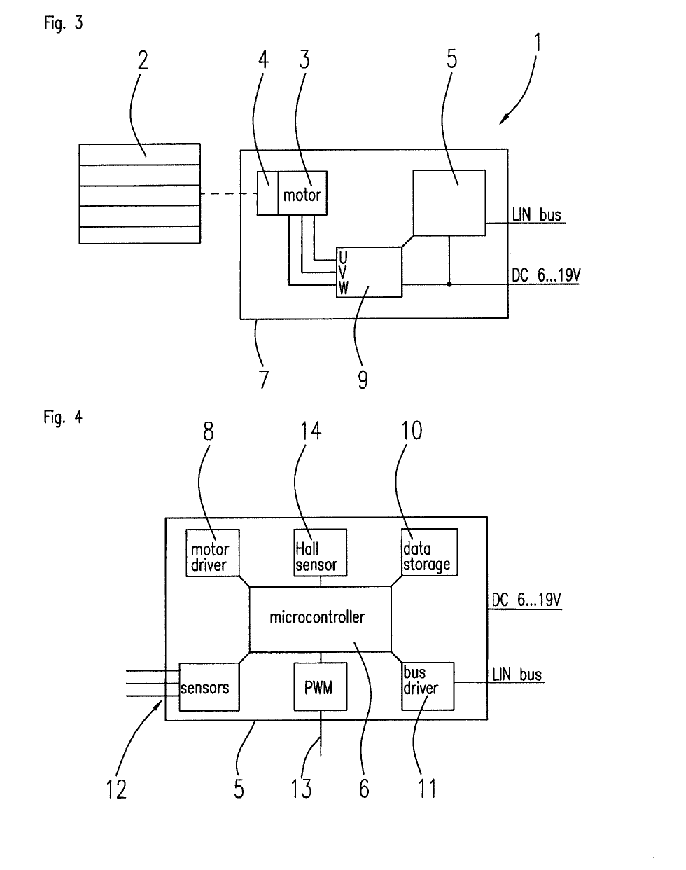

An embodiment of the invention is explained on the basis of an actuator 1 that is used to control air flaps 2 in a motor vehicle (FIG. 3). It is of course clear that the invention is in no way limited to this application and can be used in many other applications without any further changes.

The actuator 1 is a fully integrated solution in which a drive motor 3, a transmission 4 and the control electronics 5 together with a microcontroller 6 are disposed in a water- and dust-proof housing 7. Owing to its application in a motor vehicle, the actuator 1 is subject to a series of requirements that can only be realized by this integrated design.

The drive motor 3 is a brushless DC motor that is controlled via a motor driver 8 having a switching bridge. The motor driver 8 forms a part of the control of this switching bridge 9 effected through the microcontroller 6.

The motor has, for example, 6 or 12 magnetic poles and 9 stator slots. The harmonic frequencies in the EMC range are reduced thanks to the distributed geometry.

The microcontroller 6 (FIG. 4) contains the operating program that is needed for controlling the motor. An additional requirement for operation in a motor vehicle is that the microcontroller 6 recognizes and protocols error statuses. The operating program and the error data are stored in the data memory 10 of the microcontroller 6.

The microcontroller 6 is designed such that it can be directly operated at any voltages from 6V to 19 V DC, so that an extra voltage converter is not necessary. The microcontroller thereby meets the requirements for voltage pulses standardized in ISO 7637-2 and can also be operated for temporary voltage peaks of up to 45 V. Thus for motor vehicle applications, the microcontroller 6 can be operated directly on the vehicle electrical system. Moreover, all components required for operation are integrated in a control circuit 5 including a LIN interface 11, further interfaces 12, the motor driver 8, ROM, flash memory, EEPROM, PWM interface 13 and digital IO interface. The actuator 1 particularly has a LIN bus interface 11 as used in motor vehicle construction. The control circuit 5 can be configured and any errors displayed via this bus. Alternatively, the data memory or the data memories, such as the above-mentioned flash memories or EEPROMs, may on the one hand also be directly integrated in the microcontroller 6 or, on the other hand, accommodated outside the control circuit 5, for example, in a separate component.

The electric motor is controlled without using sensors, with position sensors being the main ones that can be dispensed with. The control circuit 5 has only one single Hall sensor 14 which makes it possible to determine whether the motor 3 is rotating. It is particularly advantageous if the pole/slot combination is chosen such that the number of Hall changes is a multiple of 360°.

The control electronics of the actuator is disposed on a circuit board such that all components are disposed on one side of the circuit board. In particular, the circuit board is disposed so close to the drive motor 3 that the Hall sensor 14 can likewise be disposed on the circuit board of the control electronics 5. This allows the back of the circuit board to be used as an extra cooling surface and as electrical shielding.

The control electronics 5 have comprehensive control and diagnostic functions. They can independently identify and evaluate electrical failures and deviations from operating parameters, such as under- or overvoltages, temperature, overcurrent as well as deviations in the behavior of the actuator, and then to protect itself where required, and on the command of a bus master to report error situations. For this purpose, it can contain further sensors, or other sensors can be controlled via the interface 12.

For the above-described application in a motor vehicle, it is important that operation be error free under all circumstances, since in some situations a malfunction could have an impact on personal safety.

For this reason, it is particularly important that the control electronics 5 can access correct data at all times. This applies particularly to configuration data and operating parameters that are stored in the data memory 10 of the microcontroller 6.

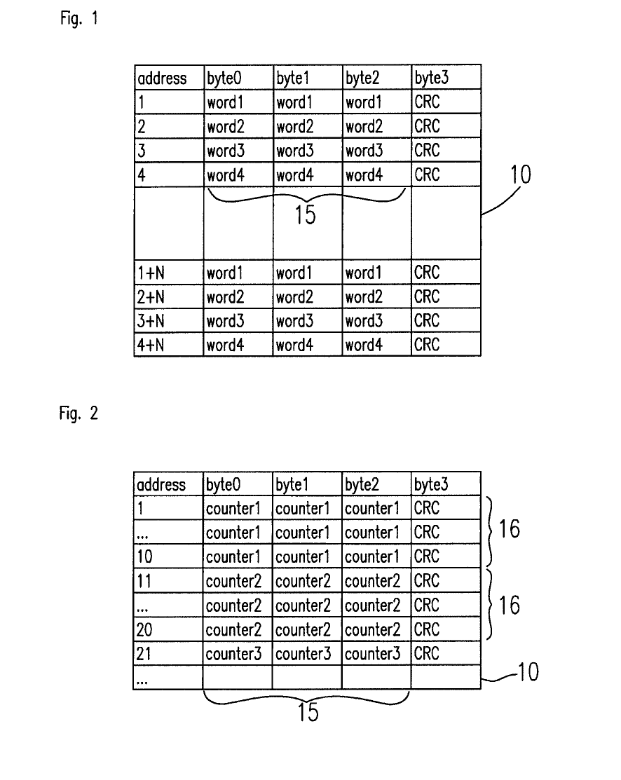

FIG. 1 schematically shows this kind of data memory 10 that is represented in the form of a table. This data memory 10 is, for example, an EEPROM or flash memory that is integrated in the microcontroller 6.

The data memory 10 in the example is organized such that at each memory address it can accept four bytes of data. These four bytes are divided into a three-byte data word 15 and a one-byte checksum (CRC). In the example, the checksum CRC is an inverted modulo-256 sum over the three bytes of the data word 15. This checksum is, for example, standard in the LIN protocol and thus sufficiently well-known.

In other applications, the data memory may be organized differently, in particular, the data words and/or the checksum may have different byte sizes.

As a data memory 10, alongside an integrated read-only memory, a separate memory element or even a hard disk can be used.

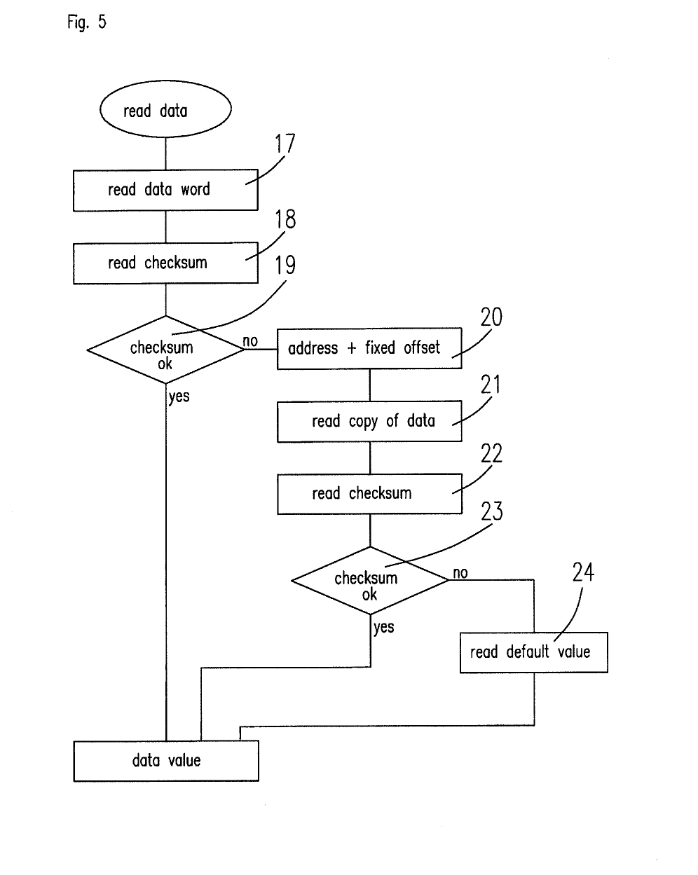

To read a data word, according to FIG. 5, the data word 15 and the checksum CRC are initially read (steps 17 and 18) from the desired address from the memory 10. Then the checksum CRC is calculated from the data word 15 and compared to the read checksum 19. If the checksums are not identical, there is a data error. In this case, the fixed address offset is initially added 20 to the address and the copy of the data word 21 and the checksum of the copy of this second address is read 22 and compared 23 again to the calculated checksum. If this data is also not valid, for the value of the data word, a default value is used 24 that allows continued safe operation of the system. If this is not possible, for example where the data is critical, an error message is issued and/or operation is denied or an error function is executed. On starting up the application, the default value 24 can be read from a separate data memory, it being also possible to provide the default value 24 with a checksum. Where required, the checksums of the default values 24 may be compared to the checksum of their respective copy. On the basis of this check, a decision can then be made whether it is necessary to copy a default value 24 into the data memory 10.

A data error may not only be caused by an error in the data memory. For example, an alteration in the data could occur during the read operation due to external influences, for instance on the signal path. It is therefore expedient if reading the data copy only takes place after a delay, so that the external influences are hopefully no longer present during the second reading. Alternatively, it is always possible to initially read from the first address for a second time before the copy at the second address is accessed, so as to eliminate or minimize such outside effects.

This method is used for all data that is stored in the data memory, particularly also for read-only data that is stored in the data memory only once. This is generally configuration data that does not change during operation.

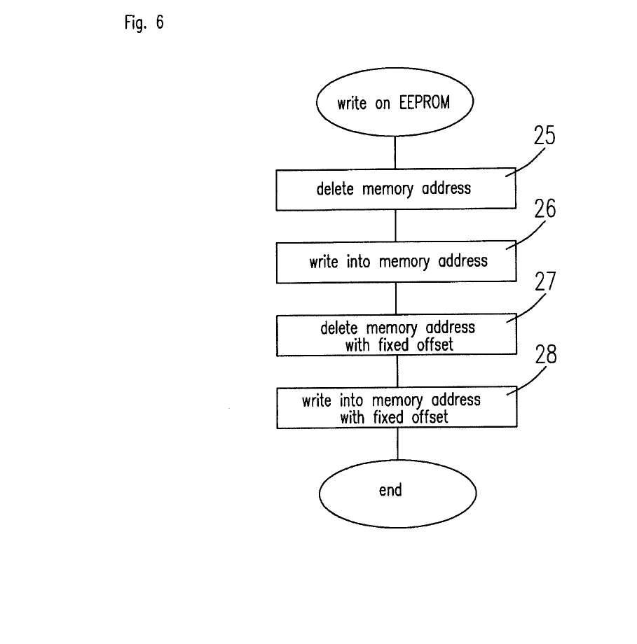

Alongside the read-only data, there also exists data that has to be written during operation. To write this kind of data word, according to FIG. 6, the checksum of the data word is first calculated. The designated memory address may be previously deleted 25 since, in the case of an EEPROM or a flash memory, this may have a positive effect on the reliability of the stored information as compared to direct overwriting of the data. Generally speaking, existing data can be overwritten without deletion, which is why this step can frequently be omitted. The data word together with the checksum is then written 26 in the designated address in the data memory.

The gist of the invention according to an embodiment is that now the same write operation is repeated (27) at the address having a fixed offset N or according to a unique assignment instruction at an address in another data memory. This means that a data word, for example, is written in address 2 and address 2+N. The data is thus available twice over. Since the second address is only written 28 after writing 26 of the first address has been completed, this ensures that there is always at least one meaningful data word in the memory.

Alternatively, to reduce the probability of a bit error, the first address may be first deleted 25 and written 26. After conclusion of the first write operation, the second address is then in turn deleted 27 and then written 28. This goes to ensure that again in this case there is always at least one meaningful data word in the memory. If both addresses were to be deleted first and then there was a power failure before the write operations, this could result in a total loss of data. As mentioned above, the two delete operations 25 and 27 shown in FIG. 6 are thus to be understood as optional steps.

The principle behind the data copy may also be extended to more than one copy. For example, a second copy may also be stored with the offset 2N.

In the example, the data memory is an EEPROM. In principle, each memory cell of the EEPROM can only carry out a limited number of delete and write operations before it becomes unusable due to internal effects. For EEPROMs, this number is, for example, 1 million or more write cycles. For flash memories, however, this number is considerably less, for example, between 100 and 10000 write cycles.

If a data word has to be frequently written, such as an operating time counter, the useful life of a memory cell can be reached after only a very short time. It is then not possible to write any more data in this address in the data memory. To ensure that the data memory can be unlimitedly used over the entire life span of the overall system, the method according to an embodiment of the invention provides an augmentation to the write and read operation.

For each data word, not only one address, but rather a full address range 16 is now reserved, which contains, for example, 10 addresses per data word (FIG. 2). The data word 15 is now randomly or cyclically stored in only one of these addresses in the address range. With 10 addresses in the address range, the data word can be written 10 times more frequently than is the useful life of an individual memory cell. Depending on requirements, the address range may comprise more or less than 10 addresses, for example, 5 or even 20.

If the useful life of an address cell is, for example, 100,000 write cycles and the specifications require 2 million write operations for a data word, at least 20 addresses have to be reserved in the address range for this data word.

In the above-mentioned application example, this method is only used to write counters in which it is not critical that the counter reading be perfectly correct. Thus no copies of the counter addresses exist in the example.

Thus to read the current counter reading in the example, initially all the addresses in the address range are read and each is checked against the checksum for validity. From all valid values, the largest is determined, which corresponds to the current value.

In this reading method if there is a data error or a data loss, only one of the previous counter values remains available, which, however, is irrelevant for the exemplary application.

If there is no valid value available in the entire address range, a default value is also set here that allows operation of the system and/or an error message is issued and/or an error function is executed.

There is now the difficulty that no counter exists that indicates in which address of an address range should be written next, since this counter would also have to be written each time. This address counter could thus only be managed in the RAM or a register of the microcontroller 6 and would then be deleted when the system is turned off.

In the method according to an embodiment of the invention, before each write operation, all the addresses in the address range are thus read and checked for validity. If there is an invalid data word, a copy can be accessed. The data words of all the valid addresses are compared to one another and the largest value is determined.

Counter readings are generally only incremented in one counter direction, so that the largest value is the latest value. The current value is then written in the next address in the address range, since this then contains the oldest value. Then a copy of the data word can be written in the mirrored address range, where available.

Alternatively, the smallest value can be determined in order to then write in this address. The address which is to be written in can also be determined in a different way, it only being important that all the addresses are written to approximately the same extent. The simplest method is thus to have a cyclical change of the addresses within the address range for a specific data word.

In microcontrollers having more resources, the data word can also be provided with a time stamp, so that the address having the oldest value can be found using this stamp.

For data memories that do not have a useful life limited by the number of write cycles, such as hard disks, the data need not be distributed over several addresses.

In the above-mentioned embodiment, the data memory preferably has a further function that offers added protection against data loss for important data. Here, each address is assigned a security level which indicates who is allowed to write in this address.

In the example of the flap actuator 1, there are three different security levels. A first security level for data that is written once only by the manufacturer of the flap actuator, such as the serial number, the production date, the batch number or other data for the unique identification of the actuator 1. This data is protected with the first security level before delivery to an original equipment manufacturer (OEM). The OEM cannot then change this data. The OEM can in turn protect special configuration data with a second security level, such that it cannot be changed at a later date, for example, in a workshop or from the end user. Such data includes, for example, installation-specific calibration data or operating parameters such as operating frequencies or suchlike.

Finally, there is a zero security level for all the data that is changed during operation such as error counters or user-configurable operating parameters. The security levels also prevent, for example, important system data from being overwritten through an error in the address calculation, since the security level of the address is evaluated and checked before each write operation.

In the above-mentioned example, access to the data memory takes place with full transparency and exclusively through functions that contain the described writing and reading method. Consequently the security levels cannot simply be circumvented.

Although the invention can mainly be used in an integrated microcontroller, it is not limited to this application.

### IDENTIFICATION REFERENCE LIST

1 Actuator
2 Air flaps
3 Drive motor
4 Transmission
5 Control electronics
6 Microcontroller
7 Housing
8 Motor driver
9 Bridge circuit
10 Data memory
11 LIN bus interface
12 Sensor interface
13 PWM interface
14 Hall sensor
15 Data word
16 Address range
17-28 Method steps
N Address offset

1. A method for reading data from an electronic memory, comprising:
the data is available in individual data words and reading only whole data words, reading the data word and a checksum (CRC) from one address, calculating the checksum (CRC) from the data word, comparing the calculated checksum to the read checksum and if the checksums do not correspond with one another, the data word is not evaluated.

2. A method according to claim 1, wherein, in the event of an invalid data word from a first address, a data word from a further address is read which lies in a same data memory as the first address, and the further address is determined by a fixed address offset (N) from the first address.

3. A method according to claim 1, wherein, in the event of an invalid data word from a first address, a data word from a further address is read that lies in a different data memory than the first address, and the further address of the other data memory is determined by a fixed assignment instruction from the first address.

4. A method according to claim 1 wherein if no valid data word can be read, a default value from another data memory is read.

5. A method according to claim 1, wherein for the data word to be read, an address range having a plurality of addresses is reserved and initially all of the reserved addresses are read and checked for validity using their checksums (CRC), and all valid data words are compared to one another and the latest valid value is determined and used further.

6. A method according to claim 1, wherein if no valid data word can be read, an error message is issued.

7. A method for writing data in an electronic memory, comprising: the data is available in individual data words and only whole data words are written, and for writing one of the data words, initially calculating a checksum (CRC) from the data word, writing the data word and the checksum (CRC) in a first address in the data memory and additionally writing the same data word and the checksum (CRC) in at least one further address.

8. A method for writing data in an electronic memory according to claim 7, wherein the further address lies either in a same data memory as the first address, wherein the further address is determined by a fixed address offset (N) from the first address or that the further address lies in a different data memory than the first address, wherein the further address of the other data memory is determined by a fixed assignment instruction from the first address.

9. A method for writing data in an electronic memory, comprising: reserving an address range having a plurality of addresses for a data word, and for each write operation the data word is written alternately in another address in the reserved address range.

10. A method according to claim 9, wherein for determining the address to be written next, all the reserved addresses in the address range for a data word are initially read and compared to one another, so as to determine a latest value, and that the data word is written in the address following the address having the latest value.

11. A microcontroller having a data memory, a reader for reading a data word from the data memory, a checksum generator for generating a checksum over the data word, and an assignment instruction calculator for assigning between at least two memory addresses, that is configured to carry out the method according to claim 1.

12. A microcontroller according to claim 11, further comprising a memory writer to write a data word and the checksum over the data word in the data memory.

13. A microcontroller according to claim 11, wherein the data memory is an EEPROM or a flash memory.
